(19) United States
(12) Patent Application Publication
(10) Pub. No.: US 2005/0198305 A1
(43) Pub. Date: Sep. 8, 2005

(54) Method and system for associating a thread with content in a social networking environment

(76) Inventors: Peter Pezaris, Delray Beach, FL (US); Michael Gersh, Delray Beach, FL (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/793,240

(22) Filed: Mar. 4, 2004

(51) Int. Cl. G06F 15/16

(52) U.S. Cl. 709/227

(57) ABSTRACT

A method and system for associating a discussion thread with content uploaded to a social networking environment is disclosed. When a first user uploads content, an alert, in the form of an e-mail message or a link on a Web page, is transmitted to one or more second users to inform them of the content. The first user assigns access control criterion defining the second users to whom the alert is sent. Optionally, access control criteria define second users who can submit comments to the discussion thread. Second users submit comments by replying to the alert or by selecting a link on a Web page containing the content. The social networking environment maintains a Web page containing messages sent to a user. The user filters the messages based on a proximity index, relationship designators, group designators and/or tier designators.

### TECHNICAL FIELD

The present invention generally relates to creating social networking environments. Specifically, the invention relates to creating a discussion thread in a social networking environment when a user adds content to the environment. The thread is associated with the content within the social networking environment. The thread is accessible by the user for discussing the content. The user can optionally permit some or all of the users in the user's social network or the social networking environment to access or submit information to the thread.

### BACKGROUND

Individuals form social networks of other individuals for a variety of reasons. Most people develop personal networks that include friends, acquaintances, and the like as a means of obtaining social interaction. In addition, people develop professional networks that include co-workers, managers, vendors, clients and the like as a means of enhancing their professional life. A person may use his personal or professional networks (individually or collectively, a person's social network) to, for example, obtain dates, enhance job searches or form a guest list for an event.

A person may attempt to expand his social network by attending social functions or conferences in order to meet new people, by requesting that someone within the person's social network introduce the person to someone outside of the person's social network, or by simply meeting someone on the street. Generally, such expansions of a person's social network require that the two people physically come in contact or at least that the two coordinate to engage in conversation at the same time. Hence, such social network expansion may be time-intensive and require substantive effort on the part of the person seeking to expand his social network.

The introduction of the Internet has provided an additional medium for expanding one's social network. Chat rooms, message boards, and interactive Web sites each provide the opportunity for people to meet other people and expand their social networks. Moreover, information may be transmitted from one person to another over the Internet by posting the information on a Web site or by sending an e-mail message to another person's e-mail address. Because the Internet allows users to interact with individuals that are remotely located, the Internet can provide a powerful tool in expanding one's social network.

In addition, Internet users need not be online at the same time in order to share information or develop a personal contact. For example, one user may send an e-mail message to a second user while the second user is not present at his computer. Despite being remotely located and not being online at the same time, the information may still be transmitted to the second individual.

Accordingly, computers and the Internet have increasingly become tools that allow people to interact with one another and to meet new people. E-dating Web sites, social networking Web sites, which are either social or professional in nature, and other similar services have been developed to meet this need.

One problem with these services is that they do not provide an organized method for transferring information within the service to a plurality of known users simultaneously. Another problem is that the services require a user to both post content and alert others to the content in separate steps.

What is needed is a method and system for associating a discussion thread with content as it is posted in or uploaded to a social networking environment.

A need exists for a method and system for distributing information regarding content to a known plurality of users simultaneously based on access control criteria assigned by a user posting the content.

The present invention is directed towards solving one or more of these problems.

### SUMMARY OF THE INVENTION

Before the present methods, systems, and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “thread” is a reference to one or more threads and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a method for associating a discussion thread with content posted to a social networking environment includes receiving content from a first user of a social networking environment, automatically generating a discussion thread for the content, and displaying the content of the first user and the discussion thread to one or more second users. The content may include one or more of a photo album, a photograph, a review, a journal, a journal entry, an event, an item for sale, a discussion topic and a poll. In an embodiment, the method further includes receiving an access control criterion for the content, permitting the second user to view the displayed content if relationship information for a second user corresponds to the access control criterion, and preventing the second user from viewing the displayed content if the relationship information for the second user does not correspond to the access control criterion. The access control criterion may include a first relationship designator, and the relationship information may include a second relationship designator. The access control criterion may include a proximity threshold, and the relationship information may include a proximity index.

In an embodiment, the method further includes receiving an access control criterion for the content, permitting the second user to view the discussion thread if relationship information for a second user corresponds to the access control criterion, and preventing the second user from viewing the discussion thread if the relationship information for the second user does not correspond to the access control criterion. The access control criterion may include a first relationship designator, and the relationship information may include a second relationship designator. The access control criterion may include a proximity threshold, and the relationship information may include a proximity index.

In an embodiment, the method further includes receiving an access control criterion for the content, permitting the second user to post a message to the discussion thread if relationship information for a second user corresponds to the access control criterion, and preventing the second user from posting a message to the discussion thread if the relationship information for the second user does not correspond to the access control criterion. The access control criterion may include a first relationship designator, and the relationship information may include a second relationship designator. The access control criterion may include a proximity threshold, and the relationship information may include a proximity index.

In an embodiment, the method further includes receiving an access control criterion for the content, determining one or more second users of the social networking environment that satisfy the access control criterion, and transmitting information pertaining to the content to the one or more second users. The information pertaining to the content may include a link to a Web page or an e-mail message.

In an embodiment, a system for associating a discussion thread with content posted to a social networking environment includes a processor, a computer-readable storage medium operably connected to the processor, a communications network operably connected to the processor, and a plurality of computer systems operably connected to the communications network. The computer-readable storage medium contains one or more programming instructions for performing a method of controlling access to content in a social networking environment including receiving content from a first user of a social networking environment, automatically generating a discussion thread for the content, and displaying the content of the first user and the discussion thread to one or more second users.

### BRIEF DESCRIPTION OF THE DRAWINGS

The accompanying drawings, which are incorporated in and form a part of the specification, illustrate embodiments of the present invention and, together with the description serve to explain the principles of the invention. The embodiments illustrated in the drawings should not be read to constitute limiting requirements, but instead are intended to assist the reader in understanding the invention.

FIG. 1 depicts a screen shot of an exemplary access control screen for controlling access to a post according to an embodiment of the present invention.

FIG. 2 depicts a screen shot of an exemplary content list including multi-tiered relationship designators denoting the creator of each content item according to an embodiment of the present invention.

FIG. 3 depicts a screen shot of an exemplary content list sorted by a proximity index according to an embodiment of the present invention.

FIG. 4 is a block diagram of exemplary internal hardware that may be used to contain or implement the program instructions of a system embodiment of the present invention.

### DETAILED DESCRIPTION

The present invention generally relates to creating social networking environments. Specifically, the invention relates to creating a discussion thread in a social networking environment when a user adds content to the environment. The thread is associated with the content within the social networking environment. The thread is accessible by the user for discussing the content. The user can optionally permit some or all of the users in the user's social network or the social networking environment to access or submit information to the thread.

A social networking environment may permit a plurality of users to interact with each other. Moreover, the present invention may permit the users to describe relationships (as defined below) with other users. A user's social network may include one or more users with which a particular user has a relationship, one or more users having relationships with the one or more users with whom the particular user has a relationship, and so on.

A relationship is a set of one or more connections between a first user and a second user. Each connection is a particular path connecting the first user and the second user within a social networking environment. A connection is either direct (i.e., no intervening users between the first user and the second user) or indirect (i.e., at least one intervening user between the first user and the second user). Each connection includes one or more direct connections (also known as “steps”). Each step in the present invention includes a relationship designator (defined below). A tier is the set of users who are an equal number of steps away from a particular user. Thus, a first user's second tier includes all users who are two steps away from the first user.

One application of the present invention is to permit users to post content that is displayed to other users. In addition, the user posting the content and other users provided with access rights may post comments pertaining to the content in an associated discussion thread. A method and system for creating a discussion thread, including methods and systems for assigning access rights and a description of potential content types, are described below.

Access Control

Access control permits a user to determine which users in a social networking environment can access particular content posted by the user and a thread associated with the content. The social networking environment may provide the user with the ability to use user-defined or system-generated parameters to control access to the content and/or the thread. Such parameters may include, for example, relationship designators, group designators, tier designators and proximity indices. These parameters are described in further detail below.

Relationship Designators

User defined parameters for access control in a social networking environment may include at least one relationship designator defining a connection between an individual and a contact (i.e., a first tier individual in conventional social networking environments). Relationship designators may include one or more of familial relationship designators, friendship relationship designators, co-worker relationship designators and business associate relationship designators. Familial relationship designators may include wife, husband, mother, father, mother-in-law, father-in-law, daughter, son, daughter-in-law, son-in-law, sister, brother, sister-in-law, brother-in-law, grandmother, grandfather, granddaughter, grandson, cousin, second cousin, aunt, uncle, nephew, niece, stepmother, stepfather, stepsister, stepbrother, stepson, stepdaughter, ex-wife, ex-husband, friend of the family, distant relative, other relative and life partner. Friendship relationship designators may include fiancé, girlfriend, boyfriend, friend, roommate, neighbor, sorority sister, fraternity brother and classmate. Co-worker relationship designators may include co-worker, manager, employee and business partner. Business associate relationship designators may include vendor, supplier, client, contractor and business contact. In an embodiment, additional or alternate relationship designators may be used for a social networking environment. In an embodiment, alternate or additional categories of relationship designators may be used. In an embodiment, relationship designators may be grouped in different categories.

In an embodiment, a relationship between two individuals may include more than one connection. For example, a user may be each of a friend, a fraternity brother, a classmate and a business partner of another user. In such an embodiment, the present invention may permit a user to enter a plurality of connections to appropriately describe the relationship between the user and an individual. The social networking environment may require the individual to separately confirm each connection in order to describe the relationship between the user and the individual accurately.

In an embodiment, the user assigns one or more relationship designators to an individual when the individual is added as a contact. The individual may receive a message from the social networking environment stating that the user would like to add the individual as a contact. In an embodiment, the social networking environment may automatically assign a second relationship designator based upon the first relationship designator assigned by the user to the individual and the genders of each of the user and the individual. For example, a male user may assign the relationship designator of “girlfriend” to a female contact. Upon acceptance of the contact relationship by the female contact, the social networking environment may automatically assign a relationship designator of “boyfriend” to the male user in the female contact's social network. In an embodiment, the social networking environment automatically assigns corresponding relationship designators for a subset of all relationship designator types, such as familial relationships. In an embodiment, the social networking environment may permit an individual to assign his or her own relationship designators to a contacting user when accepting an invitation to form a relationship or after such acceptance.

In the case where the individual to which the user assigns one or more relationship designators is not a user of the social networking environment, the individual may be required to become a user before the individual is added as a contact of the first user. In the case where the individual is already a user of the social networking environment, the environment may relate the user to the individual upon receipt of the individual's affirmative response to the user's request.

A relationship designator may be combined with a tier designator (described below) to denote a relationship within a social networking environment. For example, the user may state that content is available to all “second tier friends.” In an embodiment, the designation “second tier friends” may make content available to the friends of each of the user's contacts and, optionally, the user's contacts. In an alternate embodiment, the designation “second tier friends” may make content available to friends of each of the user's friends and, optionally, the user's friends. Additional designations and/or more particular designations may be made using embodiments of the present invention.

Group Designators

User defined parameters for access control in a social networking environment may further include a group designator. One or more users may be members of a group associated with the group designator. In an embodiment, group designators are a subset of relationship designators. A group designator may operate as a user-defined relationship designator.

A user may create a group in a social networking environment, assign a group designator to the group and invite other users to become members of the group. A user that controls the operation of the group is referred to herein as the “manager.” Other users in the group are referred to herein as “members.” The manager is also typically a member. Users who have been invited to join the group are referred to herein as “pending members.”

In an embodiment, the manager creates the group by, for example, clicking on a link to create a new group and assigning a group name to the group. Assigning the group name may further include assigning a group identifier. Once created, the manager may invite other users to become members of the group. A message may be transmitted to the pending members alerting them that the manager has requested their acceptance of group membership. Pending members may then accept or deny membership in the group. Upon acceptance, members may further invite other users to join the group.

Group members may interact within the social networking environment by sending messages to or posting content for other group members. Groups may be created for any purpose. Exemplary groups include, without limitation, scout troops, airplane enthusiasts, fraternity brothers, fans of a musical group and the like.

A user may combine a group designator with a tier designator (described below) to control access to user-specified content within a social networking environment. For example, the user may state that the content is available to “my airplane enthusiast club's family.” In an embodiment, the designation “my airplane enthusiast club's family” may make content available to the family members of each member of the airplane enthusiast club. In an embodiment, the designation “my airplane enthusiast club's family” may also make the content available to the members of the airplane enthusiast's club. Additional designations and/or more particular designations may be made using embodiments of the present invention.

Tier Designators

A tier designator may represent the shortest distance between two individuals. For example, if a first user is a friend of a second user, who is the wife of a third user, who is a co-worker of a fourth user, then the first user is in the third tier of the fourth user's social network. Likewise, the fourth user is in the third tier of the first user's social network. If the first user is additionally the manager of a fifth user, who is a friend of the fourth user, then the first user and the fourth user would each be in the second tier of the other user's social network based on their relationship via the fifth user.

Tier designators may provide one measure used to determine a proximity index (described below). In addition, tier designators may be combined with one or more relationship designators to assist in defining the strength of a relationship between two users. The use of tier designators in combination with relationship designators is described above.

Proximity Index

A social networking environment may determine proximity indices between users of the environment. A proximity index measures the closeness of the relationship between two users of the environment.

Proximity indices may permit a user to manage control of content by appropriately presenting content to the proper audience. Indeed, by properly assigning an audience proximity index, the user makes the content inherently more valuable. For example, a user may be more interested in purchasing items from a person known to them or known by a friend than from a stranger. Moreover, a review of a restaurant from a newspaper or periodical may be less persuasive than a review from someone that the user knows.

A user may use a system-generated proximity index as a parameter to determine the individuals that receive specific content from the user. The user may set a proximity index threshold for all content created by the user, all content of a particular type or particular content.

In an embodiment, the social networking environment may generate the proximity index from one or more of the following pieces of information:
The number of tiers or degrees separating the individuals
The number of distinct paths between two individuals (e.g., a first user may be the wife of a second user and a friend to a third user, where the second and third users are friends of a fourth user and where the proximity is generated from the first user to the fourth user)
The relationship type between two individuals (e.g., wife/husband vs. cousin/cousin)
The number of relationship types between two individuals (e.g., a first user may be both a friend and a co-worker of a second user)
Whether the individuals share membership in the same group, taking into account, for example, a group type (e.g., public or private) and the size of the group
Whether actual communication has occurred between the two individuals
Whether actual communication has occurred between shared contacts of the two individuals

Other or additional information may be used to compute the proximity index.

The proximity index may be, for example, a numerical value between 0 and 1, inclusive. In an embodiment, a proximity index of 1 may represent the relationship of a user to himself and may not be achievable between two distinct users.

The social networking environment may map ranges of numerical proximity index values to user-discernable labels. In an embodiment, a numerical proximity index between 0.800 and 0.999 may map to a proximity index label of “Very Close;” a numerical proximity index between 0.600 and 0.799 may map to a proximity index label of “Close;” and a numerical proximity index between 0.400 and 0.599 may map to a proximity index label of “Distant.” In an embodiment, a numerical proximity index less than 0.400 may not receive a proximity index label because the relationship between the two users is too tenuous. The above-listed numerical ranges and proximity index labels are exemplary only. Any numerical range, number of proximity index labels and/or proximity index label designators may be used for the proximity index labels.

The social networking environment may use the labels and associated icons to enable users to quickly modify settings and identify the proximity of other users. For example, an icon may be included in each row of a table containing messages or items for sale in a marketplace. A user may elect to filter his messages based on the proximity of the sender to the user, such as only viewing message from people in the user's social network who are “Very Close” or “Close.”

Other criteria may be used to control access to content. For example, a user may restrict access to all users that live within a certain radius of the user's location, have the same last name or have any other item of personal information in common. Accordingly, the social networking environment may enable the user to post content to people having similar interests even if they are unknown to the individual. Such access control may assist a user in forming a group or finding someone with a similar mindset who lives nearby.

Content Types

A user may provide access to different types of content. For example, the user may provide access to, personal information, members of the user's social network, photographs, reviews, journals, events, marketplace items, a discussion topic, a poll and any other type of content. In addition, a user may restrict items that the user views based on access control designations. The above-listed types of content associated with discussion threads will be discussed below. Although access control is discussed with respect to each of the above-listed content types, access control may be performed on unlisted content types as well.

Photographs

When a first user accesses a second user's photo page within the social networking environment, the first user may be presented with a list of the second user's photo albums. The list of photo albums may not include all photo albums produced by the second user due to a proximity threshold defined by the second user. For example, if the first user has a Distant relationship to the second user, the first user may not be able to access photo albums designated only for users who are Close or Very Close. In an embodiment, if a user accesses his own photo page, photo album or photo, the social networking environment may permit the user to perform additional functions related to managing albums and photos, such as, for example, uploading, editing or deleting photos or photo albums.

In an embodiment, the social networking environment may present the photos in formats including, without limitation, thumbnail and details. In the thumbnail format, cover images for each photo album may be displayed to the user. A cover image may be a small version of an image in the photo album or any other image. The albums may be organized in descending or ascending order of date created or accessed, alphabetical order, any other order or randomly. Multiple cover images may be displayed in each row. A name of the photo album may be displayed with the cover image. For groups in which more than one member of the group can post photos, the name of the user posting the album may also be displayed with the cover image. Selecting a cover image may display the photos in a photo album. The photos may be displayed in a reduced size format to maximize the number of photos displayed.

The details display format may list photo albums ordered by name or any other order in a table. In an embodiment, fields for the table include, without limitation, the album name, a description of the album, the number of photos in the album, the date of creation, and the number of users who have viewed the album. In an embodiment, the last column is only displayed for the owner of the photo album or, in the case of group photo albums, the group manager.

Each photo album may have a set of links associated with it that only an owner of the photo album may access. In an embodiment, these links include edit album, publish album, delete album and upload photo. The edit album link may allow the user to change album properties, such as, for example, the name of the photo album, the cover image of the photo album, a description of the album, a proximity threshold, and an ability to determine whether viewers may comment on the photo album. A proximity threshold may be set, for example, by accessing a checklist or a pulldown menu to determine the relationship strength required to access a photo or a photo album.

The publish album link may generate a notification message to all users having access to the photo album and create a thread associated with the photo album. An owner of the photo album and, if permitted by the owner, other users having access to the photos may post comments pertaining to the photos in the photo album in the thread. The delete album link may enable an owner to delete a photo album and its associated thread.

The upload photo link may permit owners to associate photos with a photo album. In an embodiment, group members may be allowed to upload photos if permitted by the group manager. The group manager may determine members that may upload photos based on setting a proximity threshold as described above.

Reviews

When a first user accesses a second user's review page within the social networking environment, the first user may be presented with a list of the second user's reviews. The list of reviews may not include all reviews created by the second user due to a proximity threshold defined by the second user. For example, if the first user has a Distant relationship with the second user, the first user may not be able to access reviews designated only for users who are Close or Very Close. In an embodiment, if a user accesses his review page or a specific review, the social networking environment may permit the user to perform additional functions related to managing reviews, such as, for example, editing or deleting the reviews.

Reviews may be displayed, for example, in chronological or alphabetical order. In an embodiment, the category for the review, the title of the review, the rating assigned to the reviewed item and the date that the review was posted, for example, may be displayed for each review. In an embodiment, the user selects a review category from a checklist or a dropdown menu. In an alternate embodiment, the user enters a review category in a text box. Review categories may include, for example, movies, books, restaurants, products, music, games and the like. If the reviewer permits comments to be added to reviews, a designation of the number of comments and a link permitting a viewer to add comments to a review, for example, may be associated with the review.

In an embodiment, each review may have one or more links associated with it that the reviewer may access. In such an embodiment, only the reviewer may have access to these links. The links may include a link to edit a review and a link to delete a review.

The edit review link may include one or more input fields, such as the category for the review, the name of the item being reviewed, the artist, genre, cuisine, product type, author, street address, city, state, country, zip code, manufacturer, console, the details of the view the rating and a proximity threshold. One or more of the above listed input fields may not be available based on the category selected by the reviewer. A proximity threshold may be set, for example, by accessing a checklist or a pulldown menu to determine the relationship strength required to view the review. Once the review is complete, the owner may post the review. The delete review link may remove the review from the social networking environment.

Journals

When a first user accesses a second user's journal page within the social networking environment, the first user may be presented with entries in the second user's journals. The list of journal entries may not include all journal entries produced by the second user due to a proximity threshold defined by the second user. For example, if the first user has a Distant relationship with the second user, the first user may not be able to access journal entries designated only for users who are Close or Very Close. In an embodiment, if a user accesses his own journal page or a specific journal entry, the social networking environment may permit the user to perform additional functions related to managing the journal and journal entries, such as, for example, editing or deleting the journal or journal entries.

Journal entries may be displayed, for example, in descending or ascending order based on the date that the entry was posted. In an embodiment, the subject of the journal entry, the author of the journal entry (in the case of group journals or newsletters), the text, photos, graphics and the like associated with the journal entry, and the date and time that the journal entry was posted, for example, may be displayed for each journal entry in the journal. The author of a journal entry may not be displayed if a user owns a journal instead of a group. If the journal owner permits comments to be added to journal entries, a designation of the number of comments and a link permitting a user to add comments to a journal entry, for example, may be associated with the journal entry.

In an embodiment, each journal entry may have one or more links associated with the entry that the journal entry owner may access. In such an embodiment, only the journal owner may have access to these links. The links may include a link to edit a journal entry and a link to delete an entry.

The edit journal entry link may include one or more input fields, such as the subject of the journal entry, the content for the journal entry and a proximity threshold. A proximity threshold may be set, for example, by accessing a checklist or a pulldown menu to determine the relationship strength required to access a journal entry. Once the journal entry is complete, the owner may post the journal entry to a journal. The delete journal entry may remove the journal entry from a journal.

In an embodiment, a single user may keep multiple journals. In such an embodiment, the social networking environment may display a list of journals to a user. The journals may be organized alphabetically or in order of the most recently accessed journal.

Events

When a first user accesses a second user's calendar page within the social networking environment, the first user may be presented with events in the second user's calendar. The list of events may not include all events recorded by the second user due to a proximity threshold defined by the second user. For example, if the first user has a Distant relationship with the second user, the first user may not be able to access events designated only for users who are Close or Very Close. In an embodiment, if a user accesses his own journal page or a specific journal entry, the social networking environment may permit the user to perform additional functions related to managing the calendar and events, such as, for example, editing or deleting the calendar or events. If the owner of the calendar permits comments to be added to an event, a designation of the number of comments and a link permitting a user to add comments to an event, for example, may be associated with each event.

Events may be displayed, for example, in chronological order. In an embodiment, the date and time of the event, the title of the event, a link to event details, the host of the event (if the event is posted on a group calendar), and the location of the event, for example, may be displayed for each event in the calendar. The host of an event may not be displayed on a user's calendar because the host is known to be the user.

In an embodiment, the social networking environment displays events in a calendar format or a list format. In an embodiment, a first user viewing an event on a second user's calendar may click on a link to automatically add the event to the first user's calendar. In an embodiment, the birthdays of a user's contacts are automatically added to the user's calendar. In an embodiment, a guest list for an event is created using access control functionality. In such an embodiment, a user on the guest list may RSVP for an upcoming event.

In an embodiment, each event may have one or more links associated with the entry that the calendar owner may access. In such an embodiment, only the calendar owner may have access to these links. The links may include a link to edit an event and a link to delete an event.

The edit event link may include one or more input fields, such as the date of the event, the time for the event, the title of the event, a description of the event, the venue for the event, a street address, a city, a state, a country, a zip code and a proximity threshold. A proximity threshold may be set, for example, by accessing a checklist or a pulldown menu to determine a relationship strength required to access an event. Once the event is complete, the owner may post the event to a calendar. The delete event may remove the event from a calendar.

Marketplace Items

When a first user accesses a second user's marketplace page within the social networking environment, the first user may be presented with items listed by the second user. The item listings may not include all items listed by the second user due to a proximity threshold defined by the second user. For example, if the first user has a Distant relationship with the second user, the first user may not be able to access marketplace items designated only for users who are Close or Very Close. In an embodiment, if a user accesses his own marketplace page or an item listing, the social networking environment may permit the user to perform additional functions related to managing the marketplace and the item listing, such as, for example, editing or deleting one or more listings. If the owner of the marketplace permits comments to be added to an item listing, a designation of the number of comments that have been made and a link permitting a user to add comments to an item listing, for example, may be associated with each item listing.

Item listings may be displayed, for example, in chronological order by the date that the item was listed. In an embodiment, a thumbnail of a photo associated with the item listing (if any), whether the user desires to sell or buy the listed item, a category for the listing, a title of the item, a price sought (in the case that the user is selling the listed item), and the date and time that the listing was posted, for example, may be displayed for each item listing in the marketplace.

In an embodiment, the social networking environment permits a user to spotlight one or more item listings to draw attention to featured items. In such an embodiment, the user may be required to have a predetermined number of listed items before the spotlighting feature is enabled.

In an embodiment, each item listing may have one or more links associated with the listing that the marketplace owner may access. In such an embodiment, only the marketplace owner may have access to these links. The links may include a link to edit an item listing and a link to delete an item listing.

The edit item listing link may include one or more input fields, such as a buy/sell indicator, an item category, a title for the item listing, a description of the listed item, the price for the item, one or more photos depicting the listed item, and a proximity threshold. A proximity threshold may be set, for example, by accessing a checklist or a pulldown menu to determine the relationship strength required to access a marketplace item. Once the event is complete, the owner may post the item listing to the marketplace. The delete event may remove the item listing from the marketplace.

Content with Associated Thread (multiMessaging)

When a first user creates or uploads content, the social networking environment may automatically generate a discussion thread associated with the content. The discussion thread may operate similar to a message board in that the first user and, optionally, one or more second users may post messages to the thread. Moreover, a user having access to the thread may view messages posted by other users. In an embodiment, the user posting the content determines which users can access the thread and the level of access that each user has. In an embodiment, one or more of the second users can view the thread, but cannot submit a message to the thread.

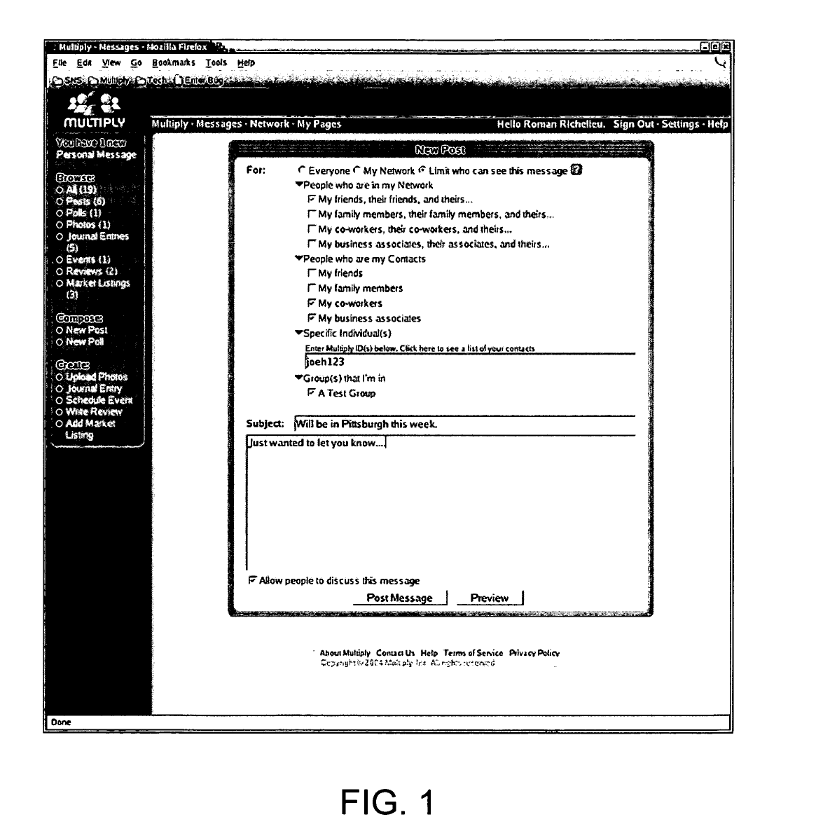

The first user may control access to the thread by designating parameters defining which second users may view and/or post comments to the thread. The parameters may be user-defined or system-generated. Each of these parameters is defined above. An exemplary access control screen for controlling access to content using user-defined parameters is depicted in FIG. 1.

In an embodiment, the one or more second users include users who are unknown to the first user. For example, the user may provide access to “second tier friends” or to Distant members of the user's social network. Each of these designations may include one or more second users who are unknown to the first user. The access control criteria may propagate through a user's social network based on the defined access for a message to determine the set of second users.

Posting content may generate a message notifying users in a user's social network with appropriate access that the content has been posted. This message may contain the posted content or an excerpt of the content. The message may further include a link to the content item. In an embodiment, a message notifying users about, for example, a new photo album may contain the album's description, a cover image and a link to the complete album. The notification message may represent the creation of a new topic (i.e., thread) that is attached to the content. Deleting the thread may be equivalent to deleting the photo album. Replies to the notification message may produce the same result as viewing the content and commenting on it.

Thus, the process may eliminate a step for a user. In conventional systems, if a user posts a photo album on a Web site, the user must separately inform other users (generally through an e-mail message or a message board post) of the presence of the photo album. The present invention informs other users of the presence of the content as it is posted. Moreover, the present invention provides a forum for discussing the content, which is accessible either by accessing a thread on a Web site where the photo album is posted or by responding to a previous message.

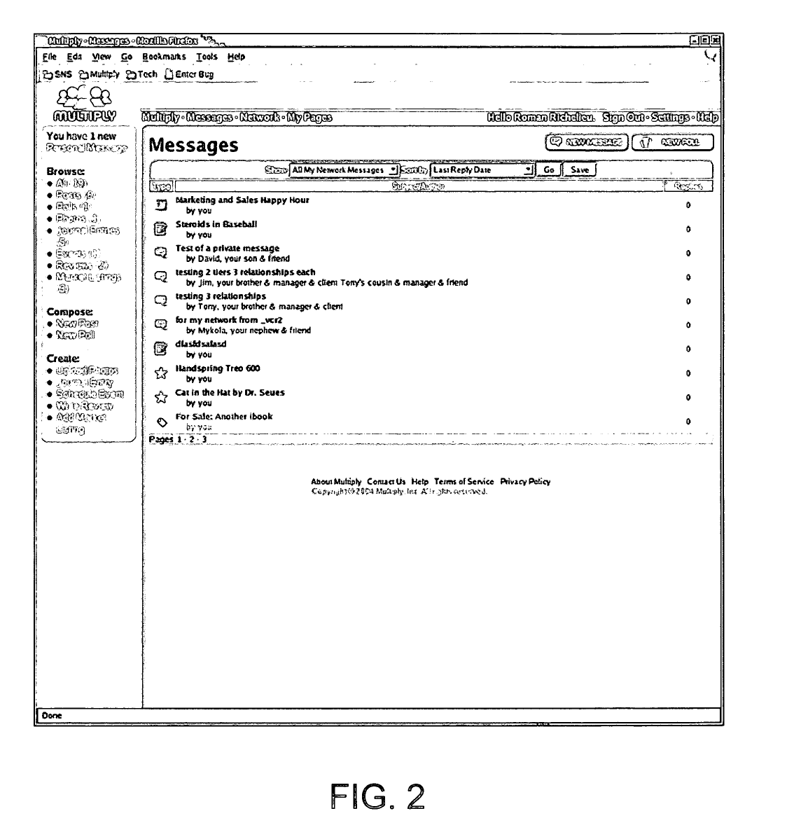

FIG. 2 depicts a screen shot of an exemplary content list including multi-tiered relationship designators denoting the creator of each content item according to an embodiment of the present invention. As shown in FIG. 2, a Web site containing the posted content and the associated thread may display the thread in a table incorporating a message board format. The table may be sorted by the time of the replies in the thread. The table may include, for example, fields for a content type, a subject, an author, a number of replies to the message, and the proximity of the message poster to the viewing user (not shown). An author entry may further include a listing of one or more connections (including relationship designators) between the viewing user and the author. Accordingly, the author field may differ for different viewing users. The proximity of the message poster to the viewing user may include a graphical indicator. The graphical indicator may be a color-coded indicator for which each color indicates a separate proximity band (e.g., green for Very Close, yellow for Close, etc.).

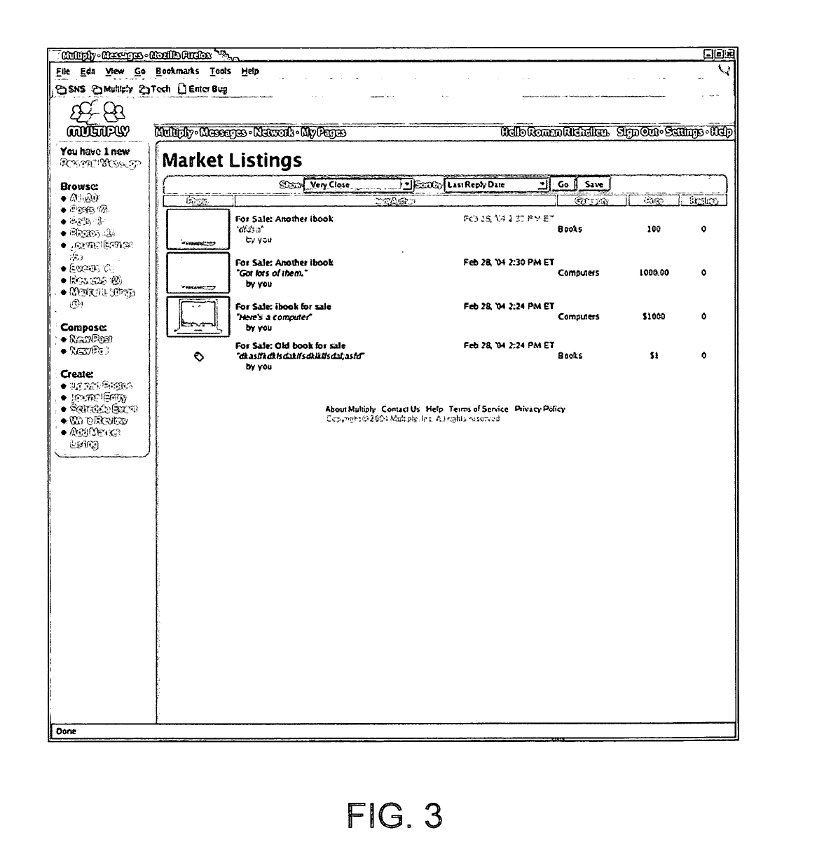

In an embodiment, the table may be filtered based on the proximity between the viewer and the posting user. For example, a user may filter the table to include content from all users in a user's social network, all users that are Close or Very Close to the user, or all users that are Very Close to the user. The latter of these is depicted in FIG. 3. Additionally or alternatively, the user may filter content based on other access control criteria, such as relationship designators, group designators and tier designators.

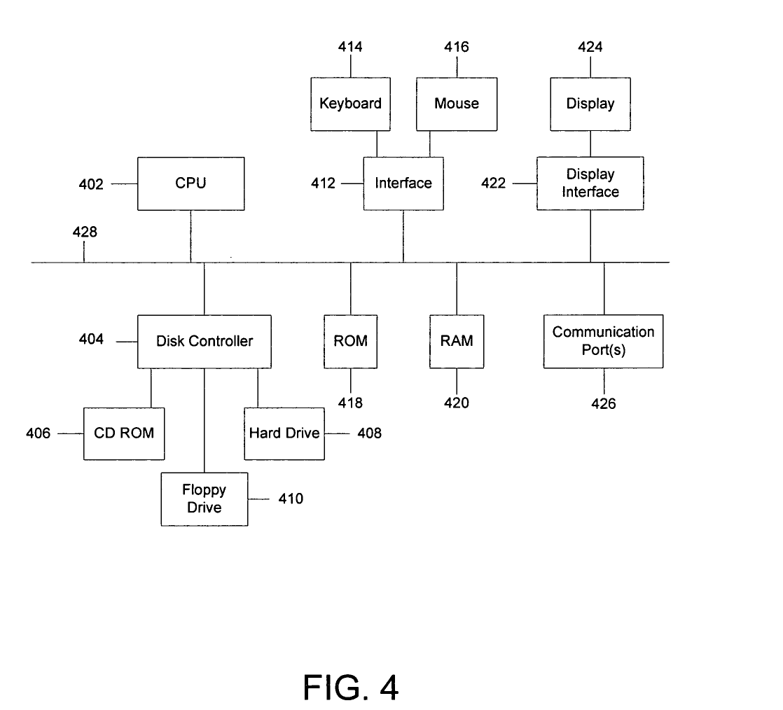

FIG. 4 is a block diagram of exemplary internal hardware that may be used to contain or implement the program instructions of a system embodiment of the present invention. Referring to FIG. 4, a bus 428 serves as the main information highway interconnecting the other illustrated components of the hardware. CPU 402 is the central processing unit of the system, performing calculations and logic operations required to execute a program. Read only memory (ROM) 418 and random access memory (RAM) 420 constitute exemplary memory devices.

A disk controller 404 interfaces with one or more optional disk drives to the system bus 428. These disk drives may be external or internal floppy disk drives such as 410, CD ROM drives 406, or external or internal hard drives 408. As indicated previously, these various disk drives and disk controllers are optional devices.

Program instructions may be stored in the ROM 418 and/or the RAM 420. Optionally, program instructions may be stored on a computer readable medium such as a floppy disk or a digital disk or other recording medium, a communications signal or a carrier wave.

An optional display interface 422 may permit information from the bus 428 to be displayed on the display 424 in audio, graphic or alphanumeric format. Communication with external devices may optionally occur using various communication ports 426. An exemplary communication port 426 may be attached to a communications network, such as the Internet or an intranet. A plurality of user computers may be attached to the communication port 426 via the communications network to provide user access to a social networking environment.

In addition to the standard computer-type components, the hardware may also include an interface 412 which allows for receipt of data from input devices such as a keyboard 414 or other input device 416 such as a remote control, pointer and/or joystick.

An embedded system may optionally be used to perform one, some or all of the operations of the present invention. Likewise, a multiprocessor system may optionally be used to perform one, some or all of the operations of the present invention.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

1. A method for associating a discussion thread with content posted to a social networking environment, the method comprising:
receiving content from a first user of a social networking environment, wherein the content does not pertain to a discussion thread;
automatically generating a discussion thread; and
associating the content and the discussion thread.

2. The method of claim 1 wherein the content comprises one or more of the following:
a photo album;
a photograph;
a review;
a journal;
a journal entry;
an event;
an item for sale;
a topic; and
a poll.

3. The method of claim 1, further comprising:
receiving an access control criterion;
if relationship information for a second user corresponds to the access control criterion, permitting the second user to view the content; and
if the relationship information for the second user does not correspond to the access control criterion, preventing the second user from viewing the content.

4. The method of claim 3 wherein the access control criterion comprises a first relationship designator and wherein the relationship information comprises a second relationship designator.

5. The method of claim 3 wherein the access control criterion comprises a proximity threshold and wherein the relationship information comprises a proximity index.

6. The method of claim 1, further comprising:
receiving an access control criterion;
if relationship information for a second user corresponds to the access control criterion, permitting the second user to view the discussion thread; and
if the relationship information for the second user does not correspond to the access control criterion, preventing the second user from viewing the discussion thread.

7. The method of claim 6 wherein the access control criterion comprises a first relationship designator and wherein the relationship information comprises a second relationship designator.

8. The method of claim 6 wherein the access control criterion comprises a proximity threshold and wherein the relationship information comprises a proximity index.

9. The method of claim 1, further comprising:
receiving an access control criterion;
if relationship information for a second user corresponds to the access control criterion, permitting the second user to post a message to the discussion thread; and
if the relationship information for the second user does not correspond to the access control criterion, preventing the second user from posting a message to the discussion thread.

10. The method of claim 9 wherein the access control criterion comprises a first relationship designator and wherein the relationship information comprises a second relationship designator.

11. The method of claim 9 wherein the access control criterion comprises a proximity threshold and wherein the relationship information comprises a proximity index.

12. The method of claim 1, further comprising:
receiving an access control criterion;
determining one or more second users of the social networking environment that satisfy the access control criterion; and
transmitting information pertaining to the content to the one or more second users.

13. The method of claim 12 wherein the information pertaining to the content comprises a link to a Web page.

14. The method of claim 12 wherein the information pertaining to the content comprises an e-mail message.

15. A system for associating a discussion thread with content posted to a social networking environment, the system comprising:
a processor;
a computer-readable storage medium operably connected to the processor;
a communications network operably connected to the processor; and
a plurality of computer systems operably connected to the communications network,
wherein the computer-readable storage medium contains one or more programming instructions for performing a method of controlling access to content in a social networking environment, the method comprising:
receiving content from a first user of a social networking environment, wherein the content does not pertain to a discussion thread,
automatically generating a discussion thread for the content, and
associating the content and the discussion thread.

16. The system of claim 15 wherein the computer-readable storage medium further contains one or more programming instructions for performing the following:
receiving an access control criterion;
if relationship information for a second user corresponds to the access control criterion, permitting the second user to view the content; and
if the relationship information for the second user does not correspond to the access control criterion, preventing the second user from viewing the content.

17. The system of claim 15 wherein the computer-readable storage medium further contains one or more programming instructions for performing the following:
receiving an access control criterion;
if relationship information for a second user corresponds to the access control criterion, permitting the second user to view the discussion thread; and
if the relationship information for the second user does not correspond to the access control criterion, preventing the second user from viewing the discussion thread.

18. The system of claim 15 wherein the computer-readable storage medium further contains one or more programming instructions for performing the following:
receiving an access control criterion;
if relationship information for a second user corresponds to the access control criterion, permitting the second user to post a message to the discussion thread; and
if the relationship information for the second user does not correspond to the access control criterion, preventing the second user from posting a message to the discussion thread.

19. The system of claim 15 wherein the computer-readable storage medium further contains one or more programming instructions for performing the following:
receiving an access control criterion;
determining one or more second users of the social networking environment that satisfy the access control criterion; and
transmitting information pertaining to the content to the one or more second users.
